(19) United States
(12) Patent Application Publication
(10) Pub. No.: US 2026/0115987 A1
(43) Pub. Date: Apr. 30, 2026

(54) INJECTION DEVICE CONTROL METHOD AND INJECTION MOLDING SYSTEM

(71) Applicant: Sodick Co., Ltd., Kanagawa (JP)

(72) Inventor: Tadashi MORIKAWA, Kanagawa (JP)

(73) Assignee: Sodick Co., Ltd., Kanagawa (JP)

(21) Appl. No.: 19/322,613

(22) Filed: Sep. 8, 2025

(30) Foreign Application Priority Data
Oct. 28, 2024 (JP) 2024-189344

(51) Int. Cl. B29C 45/78; B29C 45/76; B29C 45/77

(52) U.S. Cl. CPC B29C 45/78; B29C 45/7666; B29C 45/77; B29C 2945/76026; B29C 2945/76314; B29C 2945/76531; B29C 2945/76561; B29C 2945/76605; B29C 2945/76668; B29C 2945/76936

(57) ABSTRACT

Provided are an injection device control method, which is a control method for an injection device including a first cylinder and a second cylinder, and an injection molding system, in which an injection molding is performed with a set temperature of a heater that heats the second cylinder, a rotation speed of a screw in the second cylinder, and a cycle time as parameters. An estimated value (Q2) of energy input from the heater to a molding material and an estimated value (Q3) of energy input from the screw for shearing of the molding material are calculated, and a ratio between (Q2) and (Q3) is visualized and presented to an operator.

### CROSS-REFERENCE TO RELATED APPLICATION

This application claims the priority benefits of Japanese application No. 2024-189344, filed on Oct. 28, 2024. The entirety of the above-mentioned patent application is hereby incorporated by reference herein and made a part of this specification.

### BACKGROUND

### Technical Field

The disclosure relates to an injection device control method. The disclosure also relates to an injection molding system having an injection device.

### Related Art

Injection molding is widely used in the manufacture of plastic products because it has high degrees of freedom regarding shape while also being excellent in mass productivity. In injection molding, temperature management of molding material during plasticization or mixing of the molding material is important for ensuring consistent quality.

The temperature of molding material introduced into a cylinder for plasticizing or mixing the molding material is generally managed by temperature settings of a heater installed on the cylinder. However, even excluding the influence of dissipation to the cylinder and the like, the amount of heat that the molding material obtains during the process of plasticization or mixing generally does not match the amount of heat provided from the heater. This is because shear heat is generated in the molding material due to rotation of a screw disposed inside the cylinder.

The generation of shear heat itself is unavoidable, but excessive shear heat may lead to problems such as deterioration of physical properties of molded products, generation of excessive gas, and reduced durability of the cylinder and/or screw (for example, wear or corrosion). Therefore, it is advantageous to be able to grasp the amount of heat generated by shearing of the molding material during the process of plasticization or mixing. For example, Patent Document 1 below proposes grasping the amount of heat generation due to shearing from the difference in heater output between during operation and during stoppage of the screw.

### CITATION LIST

### Patent Document

[Patent Document 1] US2023311391 A1

However, the technology described in Patent Document 1 is limited to estimation of the amount of heat generation due to shearing. In actual injection molding, it is necessary to determine molding conditions taking into account the amount of heat generation due to shearing, and this has conventionally relied heavily on the experience of operators of the injection molding device. Moreover, even skilled operators basically require trial and error to determine molding conditions, and there has been a need to reduce work burden.

### SUMMARY

According to the specification, the following disclosures are provided.

An injection device control method is provided, in which the injection device includes a first cylinder having an injection shaft and a second cylinder connected to the first cylinder via a communication path. The method includes: trial steps and parameter update steps that are alternately performed; and a presentation step, each of the trial steps including a molding step and a calculation step. In the molding step, injection molding is performed with a set temperature of a heater that heats the second cylinder, a rotation speed of a screw disposed in the second cylinder, and a cycle time as parameters. In the calculation step, Q2, which is an estimated value of energy input from the heater to a molding material, and Q3, which is an estimated value of energy input from the screw to shearing of the molding material, are calculated, where the Q2 and the Q3 are respectively calculated based on power consumed by heating by the heater in the molding step and power consumed by rotation of the screw in the molding step. In the parameter update step, a value of at least one of the parameters is changed. In the presentation step, a ratio between the Q2 and the Q3 for each trial step is visualized and presented to an operator.

An injection molding system is provided, including: an injection device and a control device connected to the injection device. The injection device includes a first cylinder having an injection shaft; a second cylinder connected to the first cylinder via a communication path; a heater installed on an outer peripheral surface of the second cylinder; and a screw disposed in the second cylinder. The control device includes: at least one memory storing a program in which instructions are recorded; at least one processor configured to execute the instructions as a support of work for an operator; and a display device. The support includes: trial steps and parameter update steps that are alternately performed; and a presentation step, each of the trial steps including a molding step, and a calculation step. In the molding step, injection molding is performed with a set temperature of the heater, a rotation speed of the screw, and a cycle time as parameters. In the calculation step, Q2, which is an estimated value of energy input from the heater to a molding material, and Q3, which is an estimated value of energy input from the screw to shearing of the molding material, are calculated, where the Q2 and the Q3 are respectively calculated based on power consumed by heating by the heater in the molding step and power consumed by rotation of the screw in the molding step. In the parameter update step, a value of at least one of the parameters is changed. In the presentation step, a ratio between the Q2 and the Q3 for each trial step is visualized and presented to an operator.

### BRIEF DESCRIPTION OF THE DRAWINGS

FIG. 1 is a diagram showing an overview of an injection molding system according to an embodiment of the disclosure.

FIG. 2 is a diagram showing a portion of an injection molding system 1 shown in FIG. 1 that is mainly related to injection of molding material, with an exterior of an injection device 10 removed.

FIG. 3 is a schematic partial cross-sectional diagram of the injection device 10.

FIG. 4 is a diagram describing an example of a screen displayed on a display device 22 of a control device 20 by execution of work support by the injection molding system 1.

FIG. 5 is a flowchart showing an exemplary control method according to another embodiment of the disclosure.

FIG. 6 is a diagram showing steps that may be included in the trial step S1 shown in FIG. 5.

FIG. 7 is a flowchart for describing an example of parameter update in which values of the parameter are changed in the priority of set temperature Pt of a heater 12H, rotation speed Pr of a screw 12S, and cycle time Pc.

FIG. 8 is a flowchart for describing an example of parameter update in which values of the parameter are changed in the priority of set temperature Pt of the heater 12H, rotation speed Pr of the screw 12S, and cycle time Pc.

FIG. 9 is a diagram describing another example of a screen presented to an operator upon completion of the “support mode”.

FIG. 10 is a flowchart for describing another example of control steps in work support by the “support mode”.

### DESCRIPTION OF THE EMBODIMENTS

In embodiments of the disclosure, molding and parameter update are alternately performed, and a ratio between an estimated value of energy input from a heater to a molding material and an estimated value of energy input to shearing of the molding material is calculated for each molding. Furthermore, since those ratios are visualized and presented to an operator, parts that conventionally depended on the operator's experience are visualized, making it possible to achieve quality stability while reducing the operator's burden.

Hereinafter, embodiments of the disclosure will be described. Various features shown in the embodiments described below may be combined with each other. Moreover, the disclosures are established independently for each feature. In the drawings shown below, illustration of some members and the like may be omitted to avoid becoming excessively complex.

### <1. Injection Molding System>

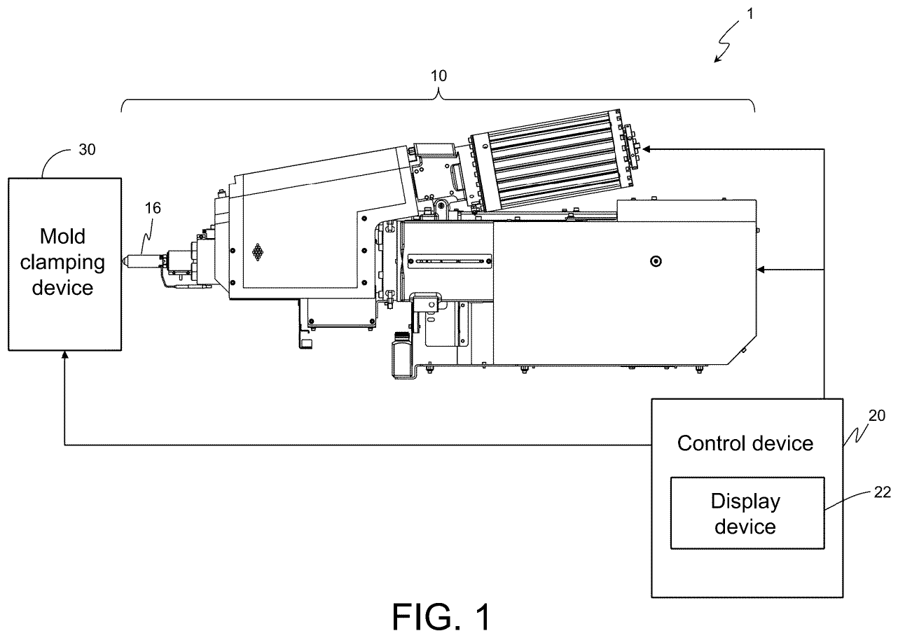

FIG. 1 shows an overview of an injection molding system according to an embodiment of the disclosure. An injection molding system 1 shown in FIG. 1 includes an injection device 10, a control device 20, and a mold clamping device 30. In the following, the injection device 10 is assumed to be a device having two independent cylinders (also called barrels) connected to each other via a communication path.

### (1.1 Injection Device 10)

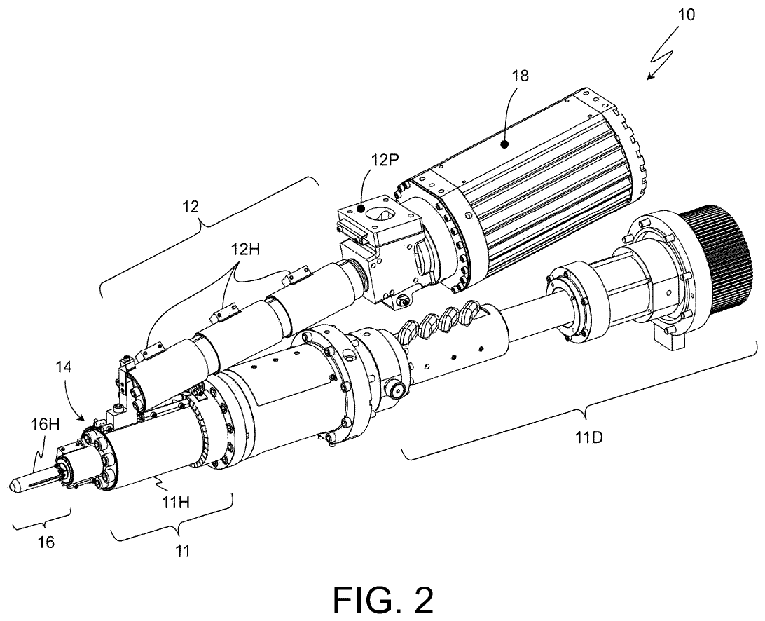

FIG. 2 shows a portion of the injection device 10 shown in FIG. 1 that is mainly related to injection of molding material, with the exterior of the injection device 10 removed. In the configuration illustrated in FIG. 2, the injection device 10 includes a first cylinder 11 and a second cylinder 12. The injection device 10 further includes a junction 14 that connects the second cylinder 12 to the first cylinder 11, and an injection nozzle 16 attached to the junction 14.

The first cylinder 11 is an injection cylinder having an injection shaft inside. At the rear end of the first cylinder 11, which is on the opposite side from the above-mentioned injection nozzle 16 in the axial direction, an injection drive device 11D for driving the injection shaft is disposed. Here, “injection shaft” refers to an injection plunger or injection screw disposed inside the injection cylinder. In this specification, the term “injection shaft” is used as a term that encompasses these structures.

On the other hand, the second cylinder 12 has a screw extending in the axial direction of the second cylinder 12 inside. At the rear end of the second cylinder 12, a screw drive device 18 is disposed. The screw drive device 18 includes an actuator such as a motor for driving the screw inside the second cylinder 12. Hereinafter, in this specification, the side closer to the injection nozzle 16 in the axial direction of each cylinder (the left side in FIG. 2) may be referred to as “front” or “front side,” and the side opposite to the injection nozzle 16 may be referred to as “rear” or “rear side.”

The second cylinder 12 further has a hopper 12P into which molding material is fed, near its rear end. The second cylinder 12 is a plasticizing cylinder that plasticizes molding material, or a mixing cylinder that mixes molding material. The second cylinder 12 functions as a plasticizing cylinder in the case of the molding material fed from the hopper 12P being thermoplastic resin, and functions as a mixing cylinder in the case of the fed molding material being thermosetting resin.

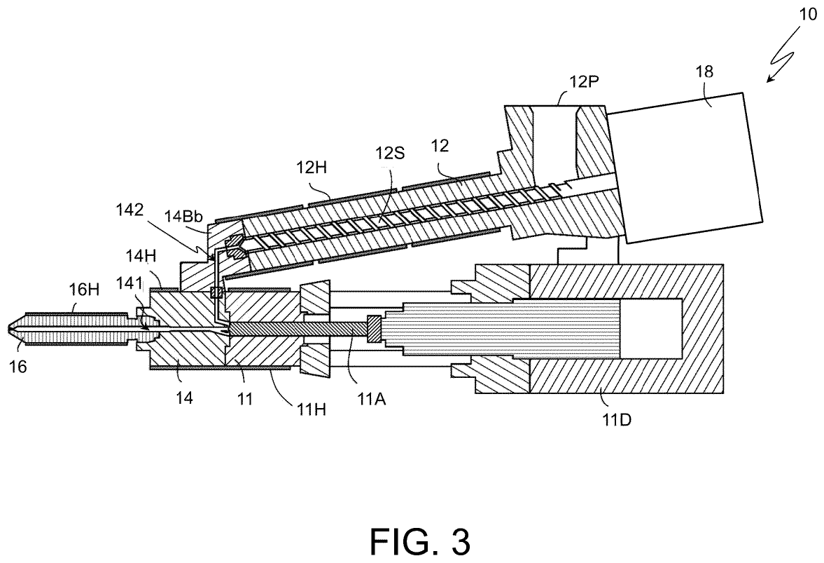

FIG. 3 schematically shows a partial cross-section of the injection device 10. As shown in FIG. 3, a screw 12S is accommodated inside the second cylinder 12. As the screw 12S, either a plasticizing screw or a mixing screw is selected according to the function of the second cylinder 12. The screw 12S is a plasticizing screw that plasticizes molding material in the case of the molding material being thermoplastic resin, and is a mixing screw that mixes molding material in the case of the molding material being thermosetting resin. In either case, since the second cylinder 12 includes the screw 12S, the injection device 10 is called a screw pre-plasticizing type injection device. For simplicity, the following description continues assuming that the screw 12S is a plasticizing screw.

As schematically shown in FIG. 3, heaters 12H (for example, multiple band heaters) are attached to the outer peripheral surface of the second cylinder 12. During operation of the injection device 10, heating by the heaters 12H is controlled by a control device 20 to be described later. The control device 20 may be configured to be capable of not only controlling the output of the heaters 12H, but also monitoring temperature changes of the second cylinder 12 due to heating from the heaters 12H. The second cylinder 12 may have a temperature control unit that includes the heaters 12H and a thermometer as part thereof.

Next, focusing on the first cylinder 11, here, as an injection shaft 11A, an injection plunger configured to be capable of reciprocating motion along the axis of the first cylinder 11 is disposed inside the first cylinder 11. The injection drive device 11D located at the rear end of the first cylinder 11 includes any actuator that drives the injection shaft 11A back and forth inside the first cylinder 11 based on instructions from the control device 20. As the injection drive device 11D, an electric cylinder or a hydraulic cylinder may be exemplified.

A junction 14 is positioned between the front end of the first cylinder 11 and the injection nozzle 16. In the example shown in FIG. 3, the junction 14 has a branch part 14Bb, and the front end of the second cylinder 12 is connected to the branch part 14Bb.

The junction 14 has a first flow path 141 and a second flow path 142 inside thereof. Among these, the first flow path 141 communicates from the space inside the first cylinder 11 to the space inside the injection nozzle 16. On the other hand, the second flow path 142 defines a communication path connecting the space inside the first cylinder 11 and the space inside the second cylinder 12. As schematically shown in FIG. 3, the second flow path 142 (communication path) passes through the inside of the branch part 14Bb and communicates with the space inside the second cylinder 12.

Similar to the outer peripheral surface of the second cylinder 12, a heater 14H (for example, a band heater) for temperature control may be attached to the outer peripheral surface of the junction 14. In this example, the first cylinder 11 and the injection nozzle 16 also have a heater 11H (for example, a band heater) and a heater 16H (for example, a coil heater) on their outer peripheral surfaces, respectively, and are configured to be capable of heating to a predetermined temperature. The outputs of these heaters may also be controlled and monitored by the control device 20.

### (1.2 Control Device 20)

Referring to FIG. 1 again, the control device 20 has at least one processor and at least one memory, and in the configuration exemplified in FIG. 1, the control device 20 further includes a display device 22 as a user interface for an operator of the injection molding system 1. A typical example of the display device 22 is a liquid crystal panel or a touch panel incorporated in an operation panel.

The control device 20 has connections with the injection device 10 and the mold clamping device 30, and controls the operations of these devices. For example, the injection drive device 11D and the screw drive device 18 of the injection device 10 include actuators for driving the injection shaft 11A or the screw 12S, as described above. The processor of the control device 20 controls the operations of those actuators according to instructions recorded in an operation program stored in the memory. The processor of the control device 20 may be realized by various arithmetic circuits such as CPU, ASIC, FPGA, and DRP. As the memory of the control device 20, known configurations such as RAM and ROM may be used. The functions of the control device 20 may be realized by any combination of hardware and software.

Here, the control device 20 also plays a role in output control of devices of various parts installed in the injection device 10, including the heater 12H. The injection device 10 may further have a device for temperature measurement of the second cylinder 12 (for example, a thermocouple), and the control device 20 may be configured to receive measured values of the temperature from the device for temperature measurement. In a typical embodiment, the control device 20 may be configured to be capable of monitoring power consumption of various parts such as the heater 12H and actuators of the screw drive device 18.

The connections between the control device 20 and the injection device 10, and between the control device 20 and the mold clamping device 30, may be either wired or wireless. Moreover, in FIG. 1, the control device 20 and the injection device 10 are shown as independent devices, but for example, the control device 20 may be incorporated into the injection device 10 to make them an integrated device.

### (1.3 Mold Clamping Device 30)

The mold clamping device 30 has a mechanism for holding a mold (not shown in FIG. 1) and a mechanism for opening and closing the mold. Liquid material is injected from the injection nozzle 16 of the injection device 10 into the mold held by the mold clamping device 30.

### <2. Work Support by Injection Molding System 1>

Next, an example of control of the injection device 10 by the control device 20 will be described. The following is an example of realization of work support for an operator of the injection molding system 1 (hereinafter simply referred to as “operator”) by the processor of the control device 20 executing instructions recorded in an operation program stored in the memory of the control device 20. The work support by the injection molding system 1 may be applied, for example, to condition setting after changing at least one of a mold and molding material. Alternatively, it is also applicable in cases such as resuming molding after interruption of continuous operation.

### (2.1 Example of Screen Display for Operator)

As will be described in detail later, in a typical embodiment of the disclosure, the injection molding system 1 itself automatically executes experimental injection molding while changing several specified parameters based on an operation program. At that time, the control device 20 calculates an estimated value of energy input to the molding material from the heater and an estimated value of energy input to the molding material in the form of shear from the screw. These estimated values are calculated for each parameter setting. In a typical embodiment, the ratio between these estimated values is presented to the operator in the form of graphs, tables, etc., for example on the display device 22 of the control device 20.

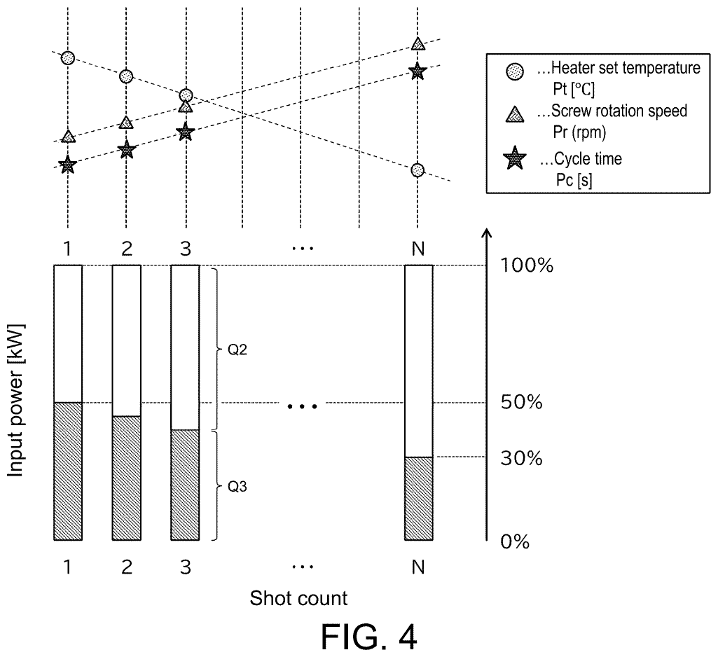

FIG. 4 shows an example of a screen displayed on the display device 22 of the control device 20 by execution of work support by the injection molding system 1. In the example shown in FIG. 4, the screen of the display device 22 is divided into upper and lower halves, and in the lower part of the screen, the above-mentioned estimated values are displayed in the form of bar graphs for each molding shot (that is, in units of injection molding cycles).

As shown in FIG. 4, in this example, the estimated value Q2 of energy input to the molding material from the heater and the estimated value Q3 of energy input to shearing of the molding material from the screw are displayed as a stacked bar graph. Here, the white graph represents the calculation result of the estimated value Q2, and the hatched graph represents the calculation result of the estimated value Q3.

The thermal energy that the molding material obtains from the outside during the plasticization process of the molding material may be broadly divided into two types: conduction from the heater 12H through the wall surface of the second cylinder 12, and heat generation caused by shearing force from the screw 12S. Here, the power per predetermined length of period (for example, one hour) input to drive the second cylinder 12 is displayed on the screen as energy given to the molding material. That is, the stacked bar graph for each shot shown in FIG. 4 shows the total power per certain period input to the molding material from the outside, and among these, the white graph related to the estimated value Q2 shows the portion of the power input to the heater 12H arranged on the outer peripheral surface of the second cylinder 12 that substantially contributed to the temperature rise of the molding material. This “substantially contributed portion” corresponds to an estimated value of the amount of heat given to the molding material from the heater 12H. On the other hand, the hatched graph related to the estimated value Q3 shows the power required for shearing the molding material, which corresponds to an estimated value of the amount of heat given to the molding material from the screw 12S in the second cylinder 12 by shearing. Each of the stacked bar graphs shown in FIG. 4 may also be viewed as representing the ratio of power required for shearing to the power input to the molding material from the outside.

In the example shown in FIG. 4, the upper part of the screen shows the history of parameter set values for each shot. Here, as parameters during molding, three parameters are adopted: a set temperature Pt of the heater 12H that heats the second cylinder 12, a rotation speed Pr of the screw 12S arranged in the second cylinder 12, and a cycle time Pc required for one cycle of injection molding. Moreover, it is understood from FIG. 4 that in this example, the set of these three parameters is changed for each cycle of injection molding. However, as will be described later, changing all of these three parameters for each cycle is not essential in the embodiments of the disclosure.

In the example shown in FIG. 4, the control device 20 displays the ratio between Q2 and Q3 for each molding shot as a stacked bar graph, with the sum of Q2 and Q3 set as 100%. In this example, it may be seen from the transition of the stacked bar graph that the ratio of Q3 to Q2 decreases with each molding where parameters are changed, and falls to 30% in the Nth shot molding. That is, from the perspective of reducing as much as possible the influence of the portion caused by shearing among the heat amount that the molding material receives during the plasticizing process, the operator can grasp at a glance from the screen presented by the injection molding system 1 that the parameter set values applied to the Nth shot are advantageous. Additionally, from the transition of the estimated value Q3 for each shot, the operator can easily grasp which parameter is dominant in reducing shear heat (has a dominant influence). That is, according to the embodiment, the operator can easily know what values should be set for the parameters to reduce local heat generation of the molding material caused by shearing. The reduction of local heat generation in the molding material inside the second cylinder 12 contributes to improving the quality of molded products and reducing material costs.

Additionally, reducing the ratio of power required for shearing the molding material out of the total power required for plasticizing (or mixing) the molding material also leads to prevention of wear or corrosion of the second cylinder 12 and/or the screw 12S. Therefore, by reducing the power ratio required for shearing the molding material, stabilization of molding material metering can be expected, and moreover, by reducing the frequency of parts replacement, effects of reducing man-hours and downtime for maintenance of the injection device 10 can be expected. Furthermore, similar effects (reduction of maintenance man-hours and downtime) due to reduction of outgas can also be expected.

Moreover, in the example shown in FIG. 4, the control device 20 presents the ratio between the estimated value Q2 and the estimated value Q3 to the operator in the form of a graph. However, the disclosure is not limited to this example, and the presentation of the ratio between estimated values (or the presentation of these estimated values themselves) may be presentation in other formats such as tables. It is also not essential that both the ratio of the estimated value Q2 to the total energy input externally to the molding material and the ratio of the estimated value Q3 are presented to the operator. This is because it is assumed that it would be sufficient to be able to grasp either ratio in the total. In the presentation of estimated values for each shot, it is also not essential that the sum of Q2 and Q3 is normalized to be 100%.

### (2.2 Exemplary Control Steps in Work Support)

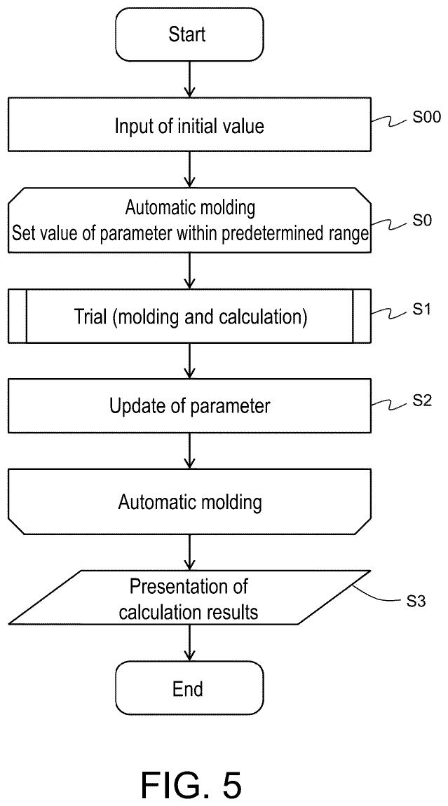

FIG. 5 shows an exemplary control method according to another embodiment of the disclosure. The control method illustrated in FIG. 5 generally includes a trial step S1, a parameter update step S2, and a presentation step S3. As understood from FIG. 5, the trial step S1 and the parameter update step S2 are alternately performed. Typically, the trial step S1 is implemented multiple times.

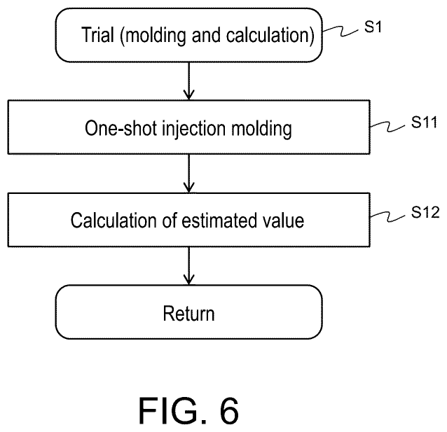

FIG. 6 shows steps that may be included in the trial step S1 shown in FIG. 5. In the example shown in FIG. 6, each trial step S1 includes a molding step S11 and a calculation step S12. In the molding step S11, injection molding is executed using the above-mentioned set temperature Pt, rotation speed Pr, and cycle time Pc as parameters. Hereinafter, examples of control steps in work support will be described with reference to FIG. 5 and FIG. 6.

### (2.2.1 Step S00: Input of Initial Values of Parameters Pt, Pr and Pc)

In typical embodiments of the disclosure, the injection molding system 1 may be configured to be capable of switching between multiple modes. The injection molding system 1 may have, for example, two modes: a “molding mode” and a “support mode.” The “molding mode” is a mode for executing molding multiple times continuously with at least the respective values of the above-mentioned parameters Pt, Pr and Pc fixed, and is selected during mass production of products. In contrast, the “support mode” may be selected, for example, when searching for molding conditions to be adopted during mass production.

The above-mentioned “support mode” is started, for example, by an operator selecting and determining a mode from a menu screen displayed on the display device 22 of the control device 20. Here, in the example shown in FIG. 5, the control device 20 executes an initial value input step S00 prior to the above-mentioned trial step S1 and parameter update step S2. In response to the “support mode” being selected, the control device 20 causes the display device 22 to display an input screen and prompts the operator to input specific numerical values as set values for each of the above-mentioned three parameters Pt, Pr and Pc (step S00 in FIG. 5). Here, for convenience of description, the initial values input by the operator are denoted as Pt(0), Pr(0) and Pc(0). Set values or the like used during previous molding may be displayed in the form of a list, allowing the operator to select initial values from the list.

(2.2.2 Step S0: Repetition by Moving Parameters within Predetermined Range)

As described above, in embodiments of the disclosure, the trial step S1 and the parameter update step S2 are alternately performed. Here, for each of the above-mentioned parameters Pt, Pr and Pc, a range (upper and lower limits) of set values is set, and within that range, the set values are changed in predetermined steps, and the trial step S1 and the parameter update step S2 are repeated (step S0 in FIG. 5). Here, the repetitive loop is conveniently named “automatic molding.” Moreover, it is not essential for the total number of repetitions of the trial step S1 and the total number of repetitions of the parameter update step S2 to match. The parameter update step S2 after the final implementation of the trial step S1 is typically skipped.

### (2.2.3 Step S1: Experimental Injection Molding and Calculation of Estimated Values)

After receiving input of the initial values of parameters Pt, Pr and Pc, the control device 20 executes the trial step S1. As shown in FIG. 6, the control device 20 first executes a molding step S11. In the molding step S11, the control device 20 causes the injection device 10 to execute one shot of injection molding under conditions where the parameters are set as the above-mentioned initial values Pt(0), Pr(0) and Pc(0). That is, the control device 20 causes the heater 12H to increase temperature with the initial value Pt(0) as the target to be reached. Additionally, based on the input of initial values from the operator, the control device 20 sends a drive signal to the screw drive device 18 to rotate the screw 12S at a rotation speed of Pr(0).

The molding material fed from the hopper 12P and plasticized inside the second cylinder 12 is sent toward the front end of the second cylinder 12 (the end part on the side close to the tip of the screw 12S in the axial direction of the second cylinder 12) as the screw 12S rotates. The molding material that reaches the front end of the second cylinder 12 is sent from the second cylinder 12 to the first cylinder 11 via the second flow path 142 inside the junction 14. The control device 20 detects completion of metering of the molding material by a predetermined amount of retraction of the injection shaft 11A (here, the injection plunger) inside the first cylinder 11, or by temporal control.

Upon detecting completion of metering of the molding material, the control device 20 causes the injection device 10 to execute a predetermined backflow prevention operation. Examples of the backflow prevention operation are described in Japanese Patent Application Laid-Open Publication No. 2013-220600 and Japanese Patent Application Laid-Open Publication No. H05-345337, so detailed description of the backflow prevention operation is omitted here. For reference, all of the disclosed content of Japanese Patent Application Laid-Open Publication No. 2013-220600 and all of the disclosed content of Japanese Patent Application Laid-Open Publication No. H05-345337 are incorporated herein by reference.

Thereafter, the injection drive device 11D receives a drive signal from the control device 20 and advances the injection plunger to inject the molding material inside the first cylinder 11 into the cavity of the mold via the first flow path 141. At this time, the backflow prevention operation prevents backflow of the molding material from the first cylinder 11 to the second cylinder 12 via the second flow path 142. After cooling of the molding material injected into the cavity, the control device 20 operates the mold clamping device 30 to open the mold and discharge the molded product from the mold by ejection with ejector pins. By releasing the backflow prevention operation and closing the mold again, one complete cycle of one shot is completed. Typically, a standby time of a predetermined length is set between shots, and therefore, the cycle time Pc is the sum of the time required for the cycle from closing the mold to discharging the molded product and the standby time. Here, the control device 20 controls the operation of the entire injection molding system 1 with the initial value Pc(0) as a target value such that the sum of one cycle of injection molding and the standby time falls within a period of a predetermined width relative to the initial value Pc(0).

Here, the control device 20 executes a calculation step S12 for estimated values following the molding step S11. More specifically, the control device 20 executes calculation of the above-mentioned estimated value Q2 and estimated value Q3 in the case where values of the parameter are initial values Pt(0), Pr(0), and Pc(0).

The calculation method for estimated value Q2 will be described. As described above, Q2 is an estimated value of the amount of heat given to the molding material from the heater 12H on the second cylinder 12, and corresponds to the portion of the electrical energy input to the heater 12H from the outside that substantially contributed to the temperature rise of the molding material. Therefore, Q2 may be calculated by, for example, the following equation (1).

$$Q 2 = W 2 - L 2 \qquad ( 1 )$$

Here, in the above equation (1), W2 may be the power consumed by heating with the heater 12H in the molding step S11, that is, the measured value of the power consumption of the heater 12H during continuous operation with the parameters set as initial values Pt(0), Pr(0), and Pc(0) (this depends on the set temperature of the heater 12H). From this, Q2 may be obtained by subtracting a loss L2 caused by heat transfer to structures such as the hopper 12P and radiation to the atmosphere. For L2, the measured value of the power consumption of the heater 12H in the case of maintaining the heater 12H of the injection device 10 in operation standby at the set temperature, or the nominal value of its capacity published by the manufacturer of the heater 12H may be used. Alternatively, the magnitude of the loss L2 may be evaluated from the current value to the heater 12H and the time until the heater 12H reaches the set temperature.

On the other hand, Q3 is an estimated value of the amount of heat given to the molding material by shearing from the screw 12S in the second cylinder 12, and is obtained as the portion of the electrical energy input to the actuator (typically an electric motor) of the screw drive device 18 for rotation of the screw 12S that substantially contributed to shearing of the molding material. That is, Q3 may be calculated by, for example, the following equation (2).

$$Q 3 = W 3 - L 3 \qquad ( 2 )$$

Here, in the above equation (2), W3 may be the power consumed by rotation of the screw 12S in the molding step S11, that is, the power required for rotation of the screw 12S during continuous operation with the parameters set as initial values Pt(0), Pr(0), and Pc(0) (power consumption of the motor connected to the screw 12S). L3 is the magnitude of loss (for example, loss in a speed reducer) that occurs in the process of power transmission from an actuator such as a motor to the screw 12S, and may be evaluated by, for example, measuring the power consumption of the motor in the case of rotating the screw 12S in a state where no molding material is input to the second cylinder 12. Alternatively, L3 may be calculated from the torque of the motor, the rotation speed of the rotor of the motor, and the time during which the motor is being driven.

L2 in the above equation (1) and L3 in the above equation (2) may be said to be quantities that basically do not depend on the resin used for the molding material. Therefore, the specific values of L2 and L3 may be acquired in advance by operating the injection molding system 1 in preparation operation, and in typical embodiments, these values are stored in advance in the memory of the control device 20. The processor of the control device 20 retrieves these values from the memory, and may calculate the estimated value Q2 and the estimated value Q3 based on the above equations (1) and (2) from these pre-stored values and the monitoring results of the power consumption of the heater 12H and the power consumption of the actuator of the screw drive device 18. The calculation of these estimated values may be executed during continuous operation of the injection device 10, or measurement values related to W2 in the above equation (1) and W3 in the above equation (2) may be acquired and stored in memory, and the calculation of estimated values may be executed at an appropriate timing. The calculated estimated values are temporarily stored in the memory of the control device 20 in a form in association with the parameter set values.

### (2.2.4 Step S2: Parameter Update)

Referring to FIG. 5 again, in response to completion of molding under the initial values Pt(0), Pr(0), and Pc(0), the control device 20 changes at least one value among the parameters Pt, Pr, and Pc (step S2 in FIG. 5). The control device 20 updates the set value of, for example, Pt among Pt, Pr, and Pc to a new value Pt(1) different from the initial value Pt(0). The specific amount of change of the set value in the parameter update may be stored in advance in the memory of the control device 20. Alternatively, an arbitrary value may be input as the amount of change in parameter update in the case of selecting the “support mode”. The magnitude of the amount of change of the parameter may or may not be constant in repetition of the parameter update step S2.

After updating the parameter set values, the control device 20 executes the above-described trial step S1 again. Here, the control device 20 causes the injection device 10 to execute injection molding under conditions where the parameter set values are at the updated Pt(1), Pr(0), and Pc(0) (step S11 in FIG. 6). Here, molding is executed again in the same manner as the initial injection molding except that the set value of the temperature of the heater 12H is set as Pt(1). That is, plasticization, metering, injection into the mold, and cooling of the molding material are executed in order. By control of the mold clamping device 30 by the control device 20, the molded product after cooling is discharged from the mold. In this way, in repetition of the trial step S1 and the parameter update step S2, the molding step S11 from the second time onward is executed under conditions where at least one value among the parameters Pt, Pr, and Pc has been changed.

The control device 20 further acquires the measured value of power consumption of the heater 12H during injection molding where the set values of the parameter set are set as Pt(1), Pr(0), and Pc(0), and the measured value of power consumption of the actuator of the screw drive device 18, and calculates estimated values Q2 and Q3 from equations (1) and (2), respectively (step S12 in FIG. 6). The values of L2 and L3 used in the calculation may be fixed. The calculated values of Q2 and Q3 obtained at this time are temporarily stored in the memory of the control device 20 in association with the parameter set values.

After execution of the second molding step S11 and calculation step S12, the control device 20 executes the parameter update step S2 again, and changes at least one set value among the parameters Pt(1), Pr(0), and Pc(0) (step S2 in FIG. 5). For example, the control device 20 updates the parameter set from Pt(1), Pr(0), and Pc(0) to Pt(2), Pr(0), and Pc(0). As described later, which of the three parameters to prioritize for updating may be determined as appropriate.

In this way, the trial step S1 and the parameter update step S2 may be alternately performed multiple times. The repetition of the trial step S1 and the parameter update step S2 may be executed as long as the above-described parameters do not exceed preset upper and lower limits. In the repetition of the trial step S1 and the parameter update step S2, the calculated values of the estimated values Q2 and Q3 for each updated parameter set are accumulated in the memory of the control device 20.

### (2.2.5 Step S3: Visualizing the Ratio Between Q2 and Q3)

In a typical embodiment, the control device 20 repeats injection molding and calculation of estimated values Q2 and Q3 while updating one or more of the parameters Pt, Pr, and Pc, and terminates the repetition of the set of trial step S1 and parameter update step S2 upon satisfaction of, for example, a predetermined termination condition. Examples of termination conditions will be described later. After completion of the repetition of experimental injection molding as described above, here, the processor of the control device 20 reads out the calculated values of estimated values Q2 and Q3 for each shot and the parameter set values from memory, and visualizes the ratio between Q2 and Q3 for each trial step S1 (step S3 in FIG. 5). For example, the control device 20 visually presents the ratio between Q2 and Q3 for each shot to the operator in the form of a graph by displaying a screen similar to that shown in FIG. 4 on the display device 22. The visual presentation to the operator may be executed by showing the ratio of Q2 or Q3 to Q1 for each shot, where the sum of Q2 and Q3 is set as Q1.

In the embodiment, in the “support mode,” the injection molding system 1 automatically executes experimental molding while changing parameters by itself. Furthermore, the ratio between Q2 and Q3 for each shot is presented to the operator in the form of a graph or the like that is easy to visually grasp. Therefore, the operator may evaluate the quality of each shot of the molded product obtained by experimental molding while referring to, for example, the above-described ratio. This makes it possible to achieve quality stability while reducing the work burden on the operator, and can reduce the man-hours required for determining molding conditions to be applied to mass production and the amount of molding material used for determining molding conditions.

According to the embodiment of the disclosure, the injection molding system 1 itself may be made to execute a search for molding conditions that may withstand mass production, regardless of the operator's experience. By selecting the “support mode,” the series of processings as described above are automatically executed, making it possible to reduce the work burden on the operator. Furthermore, in a typical embodiment of the disclosure, the parameter set values during molding and the ratio between Q2 and Q3 for each parameter set value are integrally managed and visualized in the form of graphs or the like. This enables the operator to evaluate the quality of molded products by taking into account not only the appearance of the molded products but also this numerical information. Moreover, since numerical backing may be obtained for the molding conditions, the molding conditions obtained by executing the “support mode” may be used as an indicator for condition search in subsequent molding. Such efficient search contributes to energy saving in injection molding.

In the above-described exemplary embodiment, in the calculation of estimated values Q2 and Q3 based on the above equations (1) and (2), actual measured values of power consumption acquired during operation of the injection device 10 are used as W2 and W3. It is possible to calculate the estimated values Q2 and Q3 by reading out theoretical values calculated in advance by simulation or the like from a data table, rather than using actual measured values as W2 and W3. However, the estimated values obtained in this manner may become values that deviate from reality. For example, in calculating the estimated value Q3, torque applied to the screw and the rotation speed of the screw are required, but it is difficult to accurately grasp the viscosity distribution of the molding material inside the cylinder in advance. For example, whether the screw may operate at a rotation speed that follows the set value, and how the torque of the screw changes over time during metering of the molding material as plasticization progresses, are practically unpredictable. By calculating the estimated values Q2 and Q3 using measured values during actual operation of the injection device 10 as in the embodiment, it becomes possible to obtain estimated values that are more realistic.

### (2.3 Priority in Parameter Update)

In searching for molding conditions applicable to mass production, which of the parameters Pt, Pr, and Pc should be prioritized for change may be appropriately set according to the priority of items to be emphasized during manufacturing. For example, in the parameter update step S2, the control device 20 may change values of the parameter in the priority order of, for example, the set temperature Pt of the heater 12H, the rotation speed Pr of the screw 12S, and the cycle time Pc. That is, in the first several shots, the rotation speed Pr and the cycle time Pc may be fixed, and molding may be executed by first selectively updating the set temperature Pt.

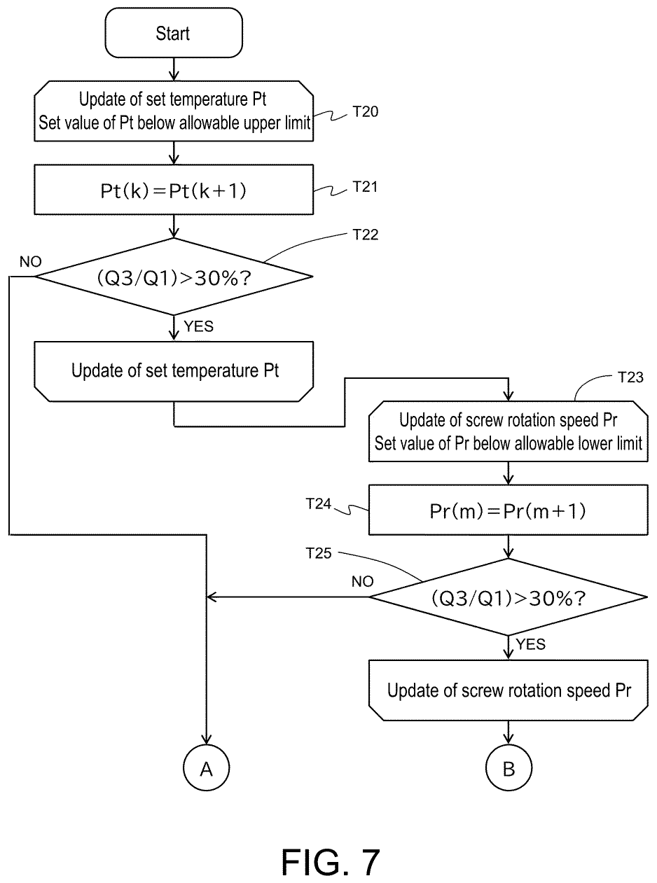

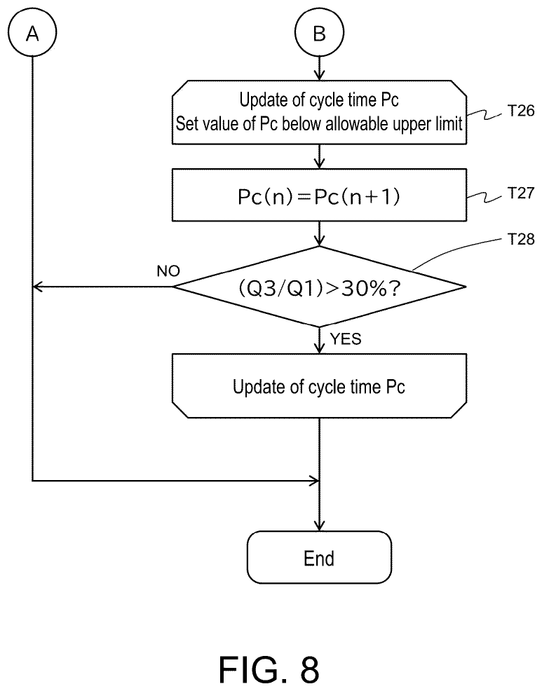

FIG. 7 and FIG. 8 show examples of parameter update in which the set temperature Pt of the heater 12H is prioritized for change. For simplicity, in FIG. 7 and FIG. 8, illustration of the portion related to the above-described trial step S1 is omitted, and only the portion related to parameter update is extracted and shown.

In the example shown in FIG. 7, the control device 20 first changes the set value of the set temperature Pt among the parameters Pt, Pr, and Pc (step T20 shown in FIG. 7). For example, after completing molding under the initial values Pt(0), Pr(0), and Pc(0), the control device 20 substitutes the next set value Pt(1) into a variable Pt (step T21 shown in FIG. 7). At this time, the set values of the rotation speed Pr and the cycle time Pc remain at the initial values Pr(0) and Pc(0). In FIG. 7 and FIG. 8, variable indices k, m, and n are all 0 or positive integers.

In the example shown in FIG. 7, the update of the set temperature Pt and the experimental molding under the updated set value are repeated until a predetermined termination condition is satisfied. Here, the sum of Q2 and Q3 is taken as Q1, and a determination is made as to whether the ratio of Q3 to Q1 (Q3/Q1) exceeds 30% (step T22 shown in FIG. 7). In the case of (Q3/Q1)>30%, the update of the set temperature Pt with the set values of the rotation speed Pr and the cycle time Pc fixed at the initial values Pr(0) and Pc(0), respectively, and the execution of the trial step S1 (not shown in FIG. 7) are repeated. In the case of the ratio (Q3/Q1) becoming 30% or less, the series of processings is terminated with the intended purpose being achieved.

Here, an update is executed such that the set value of the set temperature Pt is monotonically increased. Under such control, as long as the relationship (Q3/Q1)>30% is satisfied, the update of the set temperature Pt and the execution of the trial step S1 are repeated until the set value of the parameter Pt reaches a predetermined allowable upper limit.

In the case of the set value of the parameter Pt reaching the allowable upper limit, next, an update is executed such that the set values of the set temperature Pt and the cycle time Pc are fixed and the rotation speed Pr of the screw 12S is decreased stepwise (step T23 shown in FIG. 7). That is, the set value of the parameter Pt is set as the value at the end of the repetitive loop, the parameter Pc is set as the initial value Pc(0), and the next set value Pr(1) is substituted into a variable Pr (step T24 shown in FIG. 7).

In this example, control is executed such that the set value of the cycle time Pc is fixed while the set value of the rotation speed Pr is decreased stepwise with each parameter update. The parameter update is repeated until the set value of the parameter Pr reaches the allowable lower limit.

In the example shown in FIG. 7, a step for determining whether the relationship (Q3/Q1)>30% is satisfied is also added to the repetitive loop related to the update of the rotation speed Pr (step T25 shown in FIG. 7). That is, in this example, in the case of (Q3/Q1)≤30% resulting from the update of the set value of the rotation speed Pr, the control device 20 terminates the series of processings.

Here, decreasing the set value of the rotation speed Pr with each update means that, in the case where the standby time is common, the time required for one cycle of injection molding is extended with the parameter update. The extension of the cycle time with the update of the parameter Pr also means that the allowable lower limit of the set value of the parameter Pr depends on the magnitude of the set value of the cycle time Pc. Therefore, in the case where the time required for injection molding exceeds the current set value of the cycle time Pc due to the decrease in the rotation speed Pr, control that terminates the repetitive loop related to the update of the rotation speed Pr at that point and advances the processing to the next step may also be adopted. Such control may be said to be an example that prioritizes the maintenance of cycle time, in other words, productivity.

In the case of the set value of the parameter Pr reaching the allowable lower limit, next, as shown in FIG. 8, an update is executed such that the set values of the set temperature Pt and the rotation speed Pr are fixed and the set value of the cycle time Pc is changed (step T26 shown in FIG. 8). Specifically, the next set value Pc(1) is substituted into a variable Pc while the set values of the set temperature Pt and the rotation speed Pr are fixed (step T27 shown in FIG. 8). Here, processing is executed such that the standby time within the cycle time Pc is extended stepwise by updating the set value of the cycle time Pc. The repetitive loop related to the update of the cycle time Pc is executed until the set value of the parameter Pc reaches a predetermined allowable upper limit.

Here as well, a determination of whether the relationship (Q3/Q1)>30% is satisfied is executed (step T28 shown in FIG. 8). Therefore, in the case of (Q3/Q1)≤30% resulting from the update of the set value of the cycle time Pc, the control device 20 terminates the series of processings. Alternatively, a determination of whether to terminate the series of processings may be made based on other conditions, such as the magnitude of the variation in the ratio (Q3/Q1) for each shot accompanying the update of the cycle time Pc becoming less than 1%. According to trials that extend the standby time included in the cycle time Pc by changing the set value of the cycle time Pc to a value larger than the initial value Pc(0), as shown in FIG. 8, there is no variation in the time for plasticization of the molding material. Therefore, such trials may be said to be control that prioritizes quality over cycle time.

It goes without saying that the flow of parameter update is not limited to the examples shown in FIG. 7 and FIG. 8. For example, the following processing is also possible. In the first several shots, the rotation speed Pr and the cycle time Pc are fixed, and molding is executed by first selectively updating the set temperature Pt. That is, in the case of the index k related to the parameter Pt exceeding a predetermined update count Nt, either one of the parameters Pr and Pc (for example, Pr) is updated to a new value, the index k is initialized, and then molding with selective updating of the set temperature Pt is repeated. In the case of the index k exceeding the predetermined update count Nt, the parameter Pr is updated to a new value again. This is repeated, and in the case of the index m related to the parameter Pr exceeding a predetermined update count Nr, the parameter Pc is updated to a new value this time. Thereafter, after initializing the indices k and m, the above-described procedure is repeated until the index n related to the parameter Pc exceeds a predetermined update count Nc.

Among the parameters Pt, Pr, and Pc, by prioritizing changes to the set value of Pt, which is considered to have the greatest direct influence on plasticization of the molding material, molding conditions suitable for mass production can be searched more efficiently. Alternatively, without being limited to the above-described example, in the case where it is desired to prioritize reduction of time required per shot over quality, control may be adopted in which the control device 20 changes values of the parameter in the priority order of set temperature Pt, cycle time Pc, and rotation speed Pr.

### (2.4 Other Examples of Screen Display for Operator)

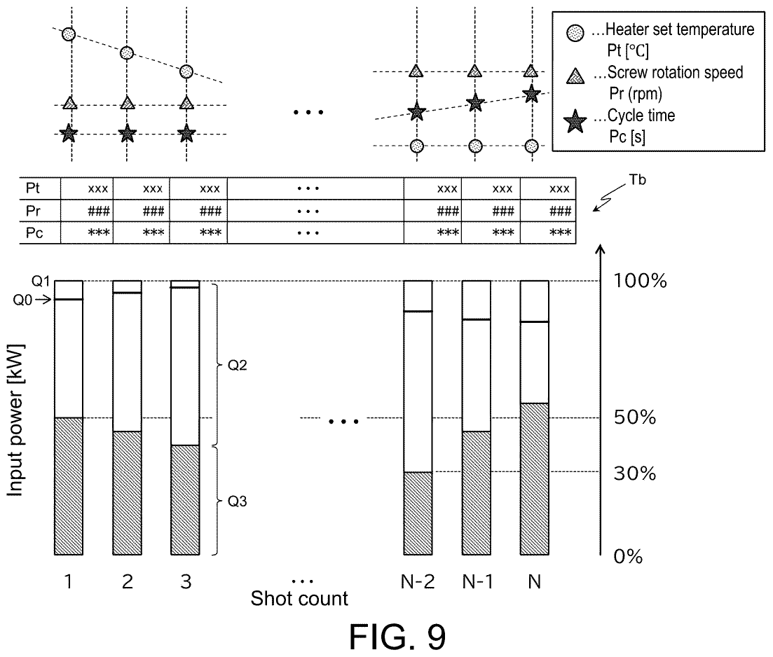

FIG. 9 shows another example of a screen presented to an operator upon completion of the “support mode”. Similar to the example described with reference to FIG. 4, in the example shown in FIG. 9, the ratio between Q2 and Q3 and the transition of parameter set values are displayed on the screen. Furthermore, in this example, the screen presented to the operator further includes a table Tb in which parameter set values for each shot are described.

The control device 20 may be configured to present to the operator the set values for each shot of the set temperature Pt of the heater 12H, the rotation speed Pr of the screw 12S, and the cycle time Pc, as in this example. By presenting the parameter set values for each shot together with the ratio between Q2 and Q3, the operator can more easily evaluate molded products for each shot while comparing them with the parameter set values. It goes without saying that the display of parameter set values is not limited to the table format as exemplified in FIG. 9.

In the example shown in FIG. 9, the control device 20 displays not only the ratio between Q2 and Q3, but also the calculated value of Q1, which is the sum of Q2 and Q3, on the screen of the display device 22. That is, in this example, it may be said that the ratio of Q2 to Q1 and the ratio of Q3 to Q1 are visualized.

In addition to these, the control device 20 may present to the operator a theoretical value Q0 of energy required for melting or fluidization of the molding material. In the example shown in FIG. 9, a horizontal line indicating the calculated value of Q0 is displayed overlapping with each bar graph.

Here, Q0 is an amount corresponding to the magnitude of energy that is essentially required to be input from the outside for melting or fluidization of the molding material, and its specific value may be calculated according to the following equation (3).

$$Q 0 = ( mc Δ T ) / P \qquad ( 3 )$$

In the above equation (3), m represents the mass of the molding material, and c represents the specific heat of the molding material. The specific value of m in equation (3) may be obtained by metering of the molding material using the first cylinder 11, and the specific value of c is clear from the specifications of the molding material to be used. ΔT in equation (3) is the temperature difference between the softening point of the molding material (here, thermoplastic resin) and the molding material before input to the second cylinder 12. A denominator P on the right side of equation (3) is the time required for molding one shot, and is introduced into equation (3) to align the dimensions with the above-mentioned estimated values Q2 and Q3.

Referring to the lower part of FIG. 9, in this example, Q1, which is the sum of Q2 and Q3, exceeds Q0 in all shots. Q0 is considered to be the minimum energy that needs to be input from the outside for melting or fluidization of the molding material. Therefore, in the case where the calculated sum of Q2 and Q3 were to fall below the theoretical value Q0, under molding conditions that give such values of Q2 and Q3, there is a high probability that the quality of the molded product cannot be ensured due to insufficient energy to adequately impart fluidity to the molding material. On the other hand, in the case where Q1 is too large relative to Q0, this means that wasteful energy is large. Therefore, by displaying the theoretical value Q0 on the screen of the display device 22, for example, in addition to the ratio of Q2 and the ratio of Q3 to Q1, the operator can visually grasp whether or not the molding conditions to be set are appropriate.

From this, the control device 20 may be configured to calculate the above-mentioned theoretical value Q0 and the value of Q1 (=Q2+Q3) for each trial step S1 and compare them. In the case where the value of Q2+Q3 falls below the calculated value of Q0, the control device 20 may notify the operator that the parameter set values that give such a relationship are not suitable for injection molding, or may exclude graphs related to the estimated values Q2 and Q3 under parameter set values that give such a relationship from the screen presented to the operator in the presentation step S3. Each trial step S1 may additionally include a step of executing a determination of whether (Q2+Q3)≥Q0 after the calculation step S12.

### (2.5 Termination Condition for Molding in “Support Mode”)

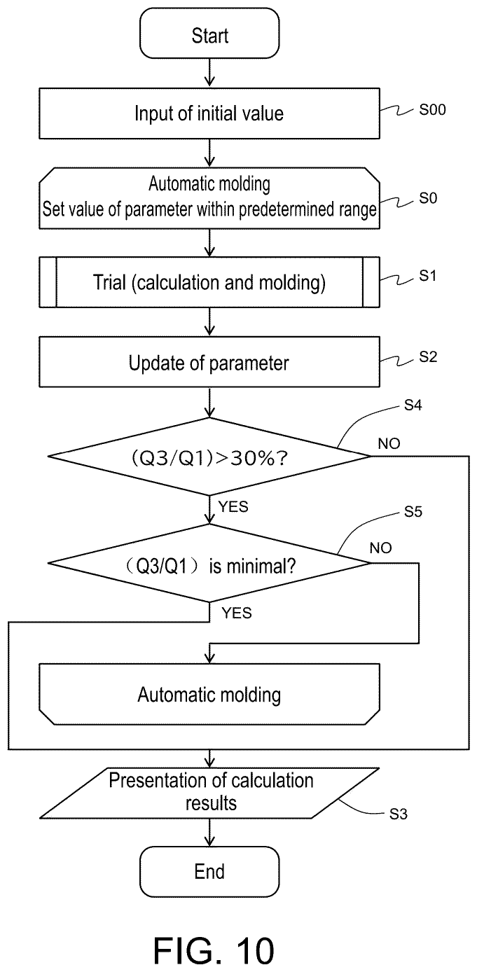

FIG. 10 shows another example of control steps in work support. Compared to the example shown in FIG. 5, FIG. 10 shows an example closer to actual operation.

The molding in “support mode” may be terminated when each of the parameters Pt, Pr, and Pc has reached the range of set values, or may be terminated when other termination conditions are satisfied. In the example shown in FIG. 10, similar to the example described with reference to FIG. 7 and FIG. 8, after the parameter update step S2, a determination is made as to whether the ratio of Q3 to Q1 (Q3/Q1) exceeds 30% (step S4 in FIG. 10).

In the example described with reference to FIG. 4, the ratio of the estimated value Q3 related to shearing of the molding material decreases with each shot, and at the Nth shot, the ratio of Q3 to Q1 has decreased to 30%. The example shown in FIG. 4 is an example where a threshold for (Q3/Q1) is predetermined to be, for example, 30%, and the “support mode” is terminated at the Nth shot where the ratio of Q3 is calculated to be 30%.

As already described, in injection molding, it is advantageous in many situations to reduce the amount of heat generation due to shearing as much as possible. In other words, it is beneficial to keep the ratio of power required for shearing the molding material low among the power input for driving the injection device 10. This is because by suppressing the amount of heat generated by shearing of the molding material as much as possible, yellowing or black spot generation due to thermal degradation can be more advantageously suppressed. From such a perspective, for example, the condition that the ratio of Q3 to Q1 becomes equal to or less than a predetermined threshold may be set as the termination condition for molding in “support mode”.

Alternatively, in multiple moldings with changed parameters, the condition that the ratio of Q3 to Q1 has turned from decreasing to increasing may be set as the termination condition for “support mode”. In the example shown in FIG. 10, after the parameter update step S2, a determination is further made as to whether the ratio of Q3 to Q1 (Q3/Q1) is minimal (step S5 in FIG. 10). In the example of FIG. 10, in the case where (Q3/Q1) is minimal, the subsequent repetition of the trial step S1 is not executed and the processing proceeds to the presentation step S3. In this way, by appropriately setting the termination condition for molding in “support mode”, molding conditions suitable for mass production can be efficiently searched.

The control device 20 may be configured to propose to the operator parameter set values that minimize the ratio (Q3/Q1) or parameter set values that make the ratio (Q3/Q1) equal to or less than a predetermined threshold after completion of the “support mode”. Alternatively, the control device 20 may be configured to automatically set such a set of parameters as initial values in the “molding mode”.

What is claimed is:

1. An injection device control method, which is a control method for an injection device comprising: a first cylinder having an injection shaft, and a second cylinder connected to the first cylinder via a communication path,
wherein the method comprises:
trial steps and parameter update steps that are alternately performed; and
a presentation step,
each of the trial steps comprising:
a molding step; and
a calculation step,
wherein in the molding step, an injection molding is performed with a set temperature of a heater that heats the second cylinder, a rotation speed of a screw disposed in the second cylinder, and a cycle time as parameters, and
in the calculation step, Q2, which is an estimated value of energy input from the heater to a molding material, and Q3, which is an estimated value of energy input from the screw for shearing of the molding material, are calculated, where the Q2 and the Q3 are respectively calculated based on power consumed by heating by the heater in the molding step and power consumed by rotation of the screw in the molding step,
in the parameter update step, a value of at least one of the parameters is changed; and
in the presentation step, a ratio between the Q2 and the Q3 for each of the trial steps is visualized and presented to an operator.

2. The injection device control method according to claim 1,
wherein in the presentation step, in addition to the ratio, a calculated value of a theoretical value Q0 of energy required for melting or fluidization of the molding material is presented.

3. The injection device control method according to claim 1,
wherein in the parameter update step, values of the parameters are changed in priority order of the set temperature, the rotation speed, and the cycle time.

4. The injection device control method according to claim 2,
wherein in the parameter update step, values of the parameters are changed in priority order of the set temperature, the rotation speed, and the cycle time.

5. The injection device control method according to claim 1,
wherein in the presentation step, in addition to the ratio, respective set values of the set temperature, the rotation speed, and the cycle time are presented.

6. The injection device control method according to claim 2,
wherein in the presentation step, in addition to the ratio, respective set values of the set temperature, the rotation speed, and the cycle time are presented.

7. The injection device control method according to claim 3,
wherein in the presentation step, in addition to the ratio, respective set values of the set temperature, the rotation speed, and the cycle time are presented.

8. The injection device control method according to claim 4,
wherein in the presentation step, in addition to the ratio, respective set values of the set temperature, the rotation speed, and the cycle time are presented.

9. An injection molding system, comprising:
an injection device; and
a control device connected to the injection device,
wherein the injection device comprises:
a first cylinder having an injection shaft;
a second cylinder connected to the first cylinder via a communication path;
a heater installed on an outer peripheral surface of the second cylinder; and
a screw disposed in the second cylinder, and
the control device comprises:
at least one memory storing a program in which instructions are recorded;
at least one processor configured to execute the instructions as a support to an operator for work; and
a display device,
wherein the support comprises:
trial steps and parameter update steps that are alternately performed; and
a presentation step,
each of the trial steps comprising:
a molding step; and
a calculation step;
wherein in the molding step, an injection molding is performed with a set temperature of the heater, a rotation speed of the screw, and a cycle time as parameters, and
in the calculation step, Q2, which is an estimated value of energy input from the heater to a molding material, and Q3, which is an estimated value of energy input from the screw for shearing of the molding material, are calculated, where the Q2 and the Q3 are respectively calculated based on power consumed by heating by the heater in the molding step and power consumed by rotation of the screw in the molding step,
wherein in the parameter update step, a value of at least one of the parameters is changed; and
in the presentation step, a ratio between the Q2 and the Q3 for each of the trial steps is visualized and presented to the operator.
